(19) United States
(12) Patent Application Publication
(10) Pub. No.: US 2011/0236719 A1
(43) Pub. Date: Sep. 29, 2011

(54) Method for Manufacturing a Coated Part Using Hot Forming Techniques

(75) Inventors: Guido Cornelis Hensen, Haarlem (NL); Wico Cornelis Verloop, Hoofddorp (NL)

(73) Assignee: TATA STEEL Ijmuiden BV, Ijmuiden (NL)

(21) Appl. No.: 13/132,116

(22) PCT Filed: Dec. 18, 2009
(86) PCT No.: PCT/EP2009/009128

§ 371 Date: Jun. 13, 2011

(30) Foreign Application Priority Data
Dec. 19, 2008 (EP) 08022125.2
Apr. 8, 2009 (EP) 09005162.4

(51) Int. Cl. B32B 15/01; B32B 15/18; C21D 6/00; C21D 7/13; B05D 3/02; B05D 3/00; B05D 7/14

(52) U.S. Cl. 428/659; 427/374.1; 148/533

(57) ABSTRACT

A method for manufacturing a coated part having very high mechanical properties using hot forming techniques. The method includes the steps of 1—providing a steel strip; 2—coating the steel strip with a layer of zinc or zinc alloy; 3—heating the coated steel to a temperature between 300° C. and the Ac1 temperature of the steel; 4—cooling the coated steel; 5—cutting a blank from the strip after step 1, 2, 3 or 4; 6—heating the blank to a temperature above the Ac1 temperature of the steel; 7—hot forming the blank into a part; and 8—hardening the hot formed part. The method can also be performed without step 4. The method can also be used for the indirect hot formed method. The method also relates to a method for manufacturing a coated steel strip, and to a coated steel strip, blank or part and a hot formed part.

The invention relates to a method for manufacturing a coated part using hot forming techniques. The invention also relates to a method for manufacturing a coated steel strip, and to a coated steel strip, blank or part and a hot formed part.

The use of hot forming techniques for the forming of a part is well known, especially for automotive purposes. Starting from a sheet that can be easily formed, the hot forming techniques provide a formed part having very high mechanical properties, such as a tensile strength above 1200 MPa.

Usually the hot forming is performed by providing a blank, heating the blank to a temperature between 900° and 1000° C., placing the heated blank in a hot forming apparatus, forming the blank into a part in the hot forming apparatus, and hardening the hot formed part.

When using uncoated steel, the hot forming can be performed under a protective atmosphere to prevent oxidation and decarburization of the steel, and after the hot forming the hot formed parts must be descaled. To overcome these drawbacks, in the last ten years it has been proposed to use coated steel sheets, which sheets are heated to a temperature above the Ac1 temperature. During the heating a diffusion layer is formed due to the heat treatment of the coating and the steel sheet, providing protection against oxidation and a good adherence of the coating to the steel sheet, also at the elevated temperatures which are used for hot forming.

Though a protective atmosphere is not necessary anymore when using coated steel sheets, the known method has some drawbacks. One of the main problems is that the heating velocity of the coated steel sheets has been found to be critical. This makes the whole process more difficult to control. It also results in the heating of a steel sheet taking a considerable time, for instance 5 minutes, whereas the hot forming in the hot forming apparatus and the subsequent hardening can be performed in less than 1 minute. Manufacturing at a high production rate, as made possible by the hot forming apparatus, can be performed by heating a number of coated steel sheets in an oven. However, when there is a delay at the hot forming apparatus the coated steel sheets remain too long in the oven, which means that they have to be scrapped. This has a considerable influence on the cost of the hot forming process. Moreover, the oven has to be very long.

It is an object of the invention to provide a method for manufacturing a coated part using hot forming techniques, which makes it possible to control the process in a more flexible and robust manner.

It is also an object of the invention to provide a method for manufacturing a coated part using hot forming techniques, which makes it possible to easily and effectively produce hot formed parts.

It is a further object of the invention to provide a method for manufacturing a coated part using hot forming techniques, which is more cost-effective than the known method.

Furthermore, it is an object of the invention to provide a coated steel strip, a coated steel sheet and a method to produce these, which can be used in the method according to the invention.

According to the invention one or more of these objects is reached by providing a method for manufacturing a coated part having very high mechanical properties using hot forming techniques, comprising the following steps:

1—providing a steel strip

2—coating the steel with a layer of zinc or zinc alloy

3—heating the coated steel to a temperature between 300° C. and the Ac1 temperature of the steel

4—cooling the coated steel

5—cutting a blank from the strip after step 1, 2, 3 or 4

6—heating the blank to a temperature above the Ac1 temperature of the steel

7—hot forming the blank into a part

8—hardening the hot formed part.

The inventors have found that this method has the big advantage that the forming of the diffusion layer is performed during step 3 of the method, wherein the coated steel is heated to a temperature between 300° C. and the Ac1 temperature. Since in this step 3 the diffusion layer is formed, the heating step just before the hot forming in the hot forming apparatus can be performed at a very high production rate, such that the heating of the coated steel sheet to a temperature above Ac1 temperature can be performed in a time interval equal to or shorter than the time needed for hot forming the heated steel sheet in the hot forming apparatus. Thus, the forming of a protective coating on the steel sheet that can withstand temperatures above the Ac1 temperature of the steel is separated from the heat treatment which is required for the austenitizing of the steel in step 6. This separation makes is possible to control the forming of the protective coating at a stage before the critical steps of the hot forming process itself, because the diffusion process can be controlled separately. Moreover, the steel sheet with a diffusion layer can be better suited to the austenitizing of the steel in step 6. It follows that the process in total is easier to control and more cost-effective as it optimises the use of the equipment.

The method according to the invention as elucidated above can also be performed without step 4, that is without an intermediate cooling of the coated steel. This means that the heating step to form the diffusion layer is directly followed by the austenitizing step.

The invention can also be used in the indirect hot forming process, in accordance with the following method for manufacturing a coated part having very high mechanical properties using hot forming techniques, comprising the following steps:

1—providing a steel strip

2—coating the steel with a layer of zinc or zinc alloy

3—heating the coated steel to a temperature between 300° C. and the Ac1 temperature of the steel

4—cooling the coated steel

5—cutting a blank from the strip and forming the blank into a part after step 1, 2, 3 or 4

6—heating the part to a temperature above the Ac1 temperature of the steel

7—hardening the part.

Here too, the step to diffuse the zinc or zinc alloy layer is separated from the austenitizing step, with the advantages as elucidated above. Usually, during the hardening step the formed part is kept in a press or other equipment to prevent springback.

Also the indirect hot forming process can be performed without step 4. This has the same consequences as in the direct forming process.

According to a preferred embodiment the coated steel is heated to a temperature between 440° C. and the Ac1 temperature of the steel in step 3, preferably between 440° C. and 800° C. At these temperatures it is possible to provide a zinc or zinc alloy diffusion layer, which is especially possible in a reasonable short time period in the temperature interval between 440° C. and 800° C.

Preferably the coated steel is heated to a temperature between 440° C. and 600° C., more preferably between 460° C. and 560° C. These are relatively low temperatures, which makes it possible to use the existing production lines.

It is also possible to heat the coated steel to a temperature between 600° C. and 700° C., preferably between 625° C. and 675° C. With these temperatures, a faster diffusion is possible.

Moreover, it is possible to heat the coated steel to a temperature between 700° C. and the Ac1 temperature, preferably between 700° C. and 800° C. Such high temperatures require specific equipment, but provide a high production rate for the diffusing step.

According to a preferred embodiment, the steel has the following composition in weight percent:

0.15<C<0.5

0.5<Mn<3.0

0.1<Si<0.5

Cr<1.0

Ti<0.2

Al<0.1

P<0.1

S<0.05

0.0005<B<0.08

optionally:

Nb<0.1

V<0.1

unavoidable impurities

the remainder being iron.

Though other metal composition are also possible, it has been found that the steel composition as given above will give very good results in most cases.

Preferably, the blank is heated to a temperature between the Ac1 temperature of the steel and 1000° C. just before the hot forming step, more preferably to a temperature between 900° C. and 1000° C. These temperatures give the best results when the coated steel sheets are formed in the hot forming apparatus.

According to a preferred embodiment of the process wherein a cooling step is performed, the steel is cooled at least 50° C. in step 4, and preferably the steel is cooled to a temperature below 100° C. in step 4, more preferably the steel is cooled to room temperature. This cooling step is meant to significantly slow down the diffusion. Though small cooling steps are possible, by cooling to low temperatures, preferably room temperature in step 4 the coated steel can be processed to form the diffusion layer and thereafter be stored and/or transported before the hot forming process is performed to provide a hot formed part. Thus, the forming of the coating with a diffusion layer on the steel strip or steel sheet is separated in place and time from the hot forming process as such. This has the advantage that the manufacturers of the hot formed parts can manufacture at high production rates, and do not have to be involved in the manufacture of the coated steel strip or sheet with the diffusion layer.

According to a preferred embodiment the coated steel is provided with an additional coating layer after step 2 or after step 4 when a cooling step is performed, the additional coating layer providing protection against corrosion. This additional layer provides an additional protection against corrosion, especially during storage and transport, but often also during the hot forming process. The additional layer can be an oil or lubricant or other regularly used protective layer, but also a special purpose layer such as an organic binder with metallic particles, such as zinc particles, which should be cured to get the required protective properties. Preferably, this special purpose layer is provided on the coated steel strip.

According to a second aspect of the invention there is provided a method for manufacturing a coated steel strip for use in the hot forming of a part, comprising the following steps:

1—providing a steel strip

2—coating the steel with a layer of zinc or zinc alloy

3—heating the coated steel to a temperature between 600° C. and the Ac1 temperature

4—cooling the coated steel.

This method for manufacturing a coated steel strip is performed independently from the hot forming process as such. The choice for a high diffusion temperature between 600°C. and the Ac1 temperature means that a relatively short production time for the forming of the diffusion layer is obtained.

Preferably, in the method the steel strip is cut to form a blank from the strip and optionally a part is formed from the blank after step 1, 2, 3 or 4. Since blanks are used in the hot forming process, it is preferred to store and transport blanks which can be directly used in the hot forming process. In the indirect forming process, a part can be formed from the blank after the blank has been cut from the strip.

Further features of the method according to the first aspect of the invention can also be used in the method according to the second aspect of the invention.

According to a third aspect of the invention a coated steel strip, blank or part has been provided with a coating of zinc or zinc alloy, wherein the outer layer of the coating on average contains more than 5 weight % Fe over a depth of 3 μm. A coated steel that has been provided with such a coating can be used in the hot forming process as such.

Preferably, the outer layer of the coating on average contains more than 10 weight % Fe over a depth of 3 μm, more preferably more than 20 weight % Fe, even more preferably more than 30 weight % Fe, still more preferably more than 40 weight %. A higher amount of Fe in the outer layer of the coating means that the coating and the Fe from the steel have better diffused.

According to a preferred embodiment, the steel of the coated steel strip, blank or part has the composition as specified in the first aspect of the invention.

According to another preferred embodiment the coated steel has been provided with an additional coating layer providing protection against corrosion, as elucidated in the first aspect of the invention.

According to the invention a hot formed coated part is provided that is manufactured using the method according to the first aspect of the invention.

The invention will be elucidated referring to some background information and a number of experiments hereinafter.

Due to the low melting (420° C.) temperature and the low evaporation (907° C.) temperature of pure zinc, using zinc-coated material for hot forming poses a challenge. The inventors have found that the presence of molten zinc makes the substrate susceptible to liquid metal assisted cracking (LMAC), and gaseous zinc in an oxygen containing atmosphere oxidizes very fast thereby causing toxic ZnO dust. According to the present interpretation of the inventors, during heating of zinc-coated steel, the coating is alloyed with iron atoms from the substrate. With more iron present in the coating, the amount of liquid during forming is minimized and the susceptibility for Zn evaporation becomes less. Thus, it is the opinion of the inventors that when more iron is present in the zinc coating, the zinc coated steel blank can be heated faster because less liquid zinc is present on the steel substrate, so LMAC and Zn evaporation are reduced.

For hot forming usually a boron type steel is used. In the experiments described below, the steel substrate is a 22MnB5 steel, which has an Ac1 temperature of approximately 720° C. The 22MnB5 steel used has the following composition:

C=0.21 weight %

Mn=1.17 weight %

Si=0.18 weight %

Cr=0.25 weight %

Ti=0.033 weight %

B=0.0026 weight %

inevitable impurities (including Al, P and S)

the remainder being iron.

Experiments have been performed in which the 22MnB5 steel substrates have been galvannealed with a coating weight of 65 g/m² per side. The coated substrate have been heated and kept at a top temperature T1 for a number of seconds t1, after which the substrates have been cooled to room temperature.

TABLE 1
Fe content a 3 μm from coating surface for different heat treatments

| | | | Fe content at 3 μm | |
|---|---|---|---|---|
| | T1 | | from coating | This |
| Experiment | [° C.] | t1 [s] | surface [wt %] | invention |
| 1 | 0 | 0 | 10 | |
| 2 | 650 | 0 | >15 | |
| 3 | 700 | 300 | >25 | ✓ |

The experiments 1-3 show that a relatively high temperature T1 and a relatively long holding time should be chosen for a galvannealed zinc layer of 65 g/m² per side to provide a Fe content in the coating that reduces the amount of liquid zinc in the coating substantially at hot forming temperatures.

In further experiments, the galvannealed blanks having a coating weight of 65 g/m² per side are first heated and kept at a top temperature T1 for a number of seconds t1, after which they are cooled to room temperature. These blanks are then reheated and kept at a hot forming temperature T2 during 10 seconds, after which they are hot formed and quenched.

TABLE 2
results for different heat treatments

| | T1 | | | White | Micro- | This |
|---|---|---|---|---|---|---|
| Experiment | [° C.] | t1 [s] | T2 [° C.] | powder? | cracks? | invention |
| 4 | 0 | 0 | 870 | yes | yes | |
| 5 | 650 | 0 | 870 | yes | yes | |
| 6 | 700 | 300 | 870 | no | no | ✓ |

The experiments 4-6 show that the blank of experiment 3 that is heated to a hot forming temperature of 870° C. and subsequently hot formed in a hot press does not show white powder, which is a sign of zinc oxide, and also does not show microcracks.

Furthermore an experiment has been performed in which no intermediate cooling step is used. Galvannealed blanks having a coating weight of 65 g/m² per side are used. In one experiment no top temperature T1 is used at which the temperature is kept constant for a number of seconds t1; in the second experiment the temperature is kept constant at 650° C. during 1000 seconds.

TABLE 3
results for different heat treatments

| | T1 | | T2 | White | Micro- | This |
|---|---|---|---|---|---|---|
| Experiment | [° C.] | t1 [s] | [° C.] | powder? | cracks? | invention |
| 7 | 0 | 0 | 900 | yes | yes | |
| 8 | 650 | 1000 | 900 | no | no | ✓ |

Experiments 7 and 8 show that the galvannealed blank is kept at a temperature below the Ac1 temperature of the substrate during a relatively long period of time to prevent the forming of white powder and microcracks.

1. A method for manufacturing a coated part having very high mechanical properties using hot forming techniques, comprising the following steps of:
a—providing a steel strip
b—coating the steel with a layer of zinc or zinc alloy
c—heating the coated steel to a temperature between 300° C. and the Ac1 temperature of the steel
d—optionally cooling the coated steel after the heating of step c
e—cutting a blank from the strip after step b
f—heating the blank to a temperature above the Ac1 temperature of the steel
g—hot forming the blank into a part
h—hardening the hot formed part.

2. The method according to claim 1, comprising said cooling the coated steel after the heating of step c.

3. A method for manufacturing a coated part having very high mechanical properties using hot forming techniques, comprising the following steps of:
a—providing a steel strip
b—coating the steel with a layer of zinc or zinc alloy
c—heating the coated steel to a temperature between 600° C. and the Ac1 temperature of the steel
d—optionally cooling the coated steel
e—cutting a blank from the strip after step 1, 2, 3 or 4 a, b c or d
f—heating the blank to a temperature above the Ac1 temperature of the steel
g—hot forming the blank into a part
h—hardening the hot formed part.

4. The method according to claim 3, comprising said cooling the coated steel after the heating of step c.

5. The method according to claim 1, wherein the coated steel is heated to a temperature between 440° C. and the Ac1 temperature of the steel in step c.

6. The method according to claim 5, wherein the coated steel is heated to a temperature between 440° C. and 600° C. in step c.

7. The method according to claim 5, wherein the coated steel is heated to a temperature between 600° C. and 700° C. in step c.

8. The method according to claim 5, wherein the coated steel is heated to a temperature between 700° C. and the Ac1 temperature in step c.

9. The method according to claim 1, wherein the steel comprises the following composition in weight percent:
0.5<C<0.5
0.5<Mn<3.0
0.1<Si<0.5
Cr<1.0
Ti<0.2
Al<0.1
P<0.1
S<0.05
0.0005<B<0.08
optionally:
Nb<0.1
V<0.1
unavoidable impurities
the remainder being iron.

10. The method according to claim 1, wherein the blank is heated to a temperature between the Ac1 temperature of the steel and 1000° C. in step f.

11. The method according to claim 1, wherein the steel is cooled at least 50° C. in step d.

12. The method according to claim 1, wherein the coated steel is provided with an additional coating layer for providing protection against corrosion after a step selected from the group consisting of step b and step d.

13. Method A method for manufacturing a coated steel strip for use in the hot forming of a part, comprising the following steps:
a—providing a steel strip
b—coating the steel with a layer of zinc or zinc alloy
c—heating the coated steel to a temperature between 600° C. and the Ac1 temperature of the steel
d—cooling the coated steel.

14. The method according to claim 13, wherein the steel strip is cut to form a blank from the strip and optionally a part is formed from the blank after a step selected from the group consisting of steps a, b, c and d.

15. (canceled)

16. A coated steel strip, blank or part provided with a coating of zinc or zinc alloy, wherein the outer layer of the coating on average contains more than 5 weight % Fe over a depth of 3 μm.

17. A coated steel strip, blank or part according to claim 16, wherein the outer layer of the coating on average contains more than 10 weight % Fe over a depth of 3 μm.

18. A coated steel strip, blank or part according to claim 16, wherein the steel comprises the composition of:
0.15<C<0.5
0.5<Mn<3.0
0.1<Si<0.5
Cr<1.0
Ti<0.2
Al<0.1
P<0.1
S<0.05
0.0005<B<0.08
optionally:
Nb<0.1
V<0.1
unavoidable impurities
the remainder being iron.

19. A coated steel strip, blank or part according to claim 16, wherein the coated steel has been provided with an additional coating layer providing protection against corrosion.

20. A part provided by performing the method according to claim 1.

21. The method according to claim 5, wherein the coated steel is heated to a temperature between 440° C. and 800° C. in step c.

22. The method according to claim 5, wherein the coated steel is heated to a temperature between 460° C. and 560° C. in step c.

23. The method according to claim 5, wherein the coated steel is heated to a temperature between 625° C. and 675° C. in step c.

24. The method according to claim 5, wherein the coated steel is heated to a temperature between 700° C. and 800° C. in step c.

25. The method according to claim 3, wherein the steel comprises the following composition in weight percent:
0.15<C<0.5
0.5<Mn<3.0
0.1<Si<0.5
Cr<1.0
Ti<0.2
Al<0.1
P<0.1
S<0.05
0.0005<B<0.08
optionally:
Nb<0.1
V<0.1
unavoidable impurities
the remainder being iron.

26. The method according to claim 1, wherein the blank is heated to a temperature between 900° C. and 1000° C. in step f.

27. The method according to claim 3, wherein the blank is heated to a temperature between the Ac1 temperature of the steel and 1000° C. in step f.

28. The method according to claim 3, wherein the blank is heated to a temperature between 900° C. and 1000° C. in step f.

29. The method according to claim 1, wherein the steel is cooled in step d to room temperature.

30. The method according to claim 3, wherein the steel is cooled at least 50° C. in step d.

31. The method according to claim 3, wherein the steel is cooled in step d to room temperature.

32. The method according to claim 3, wherein the coated steel is provided with an additional coating layer for providing protection against corrosion after a step selected from the group consisting of step b and step d.

33. The method according to claim 13, wherein the coated steel is heated to a temperature between 600° C. and 700° C. in step c.

34. The method according to claim 13, wherein the coated steel is heated to a temperature between 700° C. and the Ac1 temperature in step c.

35. The method according to claim 13, wherein the steel comprises the following composition in weight percent:
0.15<C<0.5
0.5<Mn<3.0
0.1<Si<0.5
Cr<1.0
Ti<0.2
Al<0.1
P<0.1
S<0.05
0.0005<B<0.08
optionally:
Nb<0.1
V<0.1
unavoidable impurities
the remainder being iron.

36. The method according to claim 14, wherein the blank is heated to a temperature between the Ac1 temperature of the steel and 1000° C. after step d.

37. The method according to claim 13, wherein the steel is cooled at least 50° C. in step d.

38. The method according to claim 13, wherein the coated steel is provided with an additional coating layer for providing protection against corrosion after a step selected from the group consisting of step b and step d.

39. A coated steel strip, blank or part according to claim 16, wherein the outer layer of the coating on average contains more than 30 weight % Fe over a depth of 3 μm.

40. A part provided by performing the method according to claim 3.
